(19) United States
(12) Patent Application Publication
(10) Pub. No.: US 2025/0057363 A1
(43) Pub. Date: Feb. 20, 2025

(54) Spring Coil Whisk

(71) Applicant: Claudia Vazquez, Los Angeles, CA (US)

(72) Inventor: Claudia Vazquez, Los Angeles, CA (US)

(21) Appl. No.: 18/414,704

(22) Filed: Jan. 17, 2024

Related U.S. Application Data
(60) Provisional application No. 63/520,587, filed on Aug. 18, 2023.

(51) Int. Cl. A47J 43/10

(52) U.S. Cl. CPC A47J 43/1087

(57) ABSTRACT

A spring coil whisk for mixing or foaming one or more materials including dry materials and liquids. The spring coil whisk may include a cap, a handle and a spring at the base. The cap and spring may include an ornamental design.

### BACKGROUND OF THE INVENTION

### Field of the Invention

The present invention relates generally to a whisk for mixing and foaming liquid and/or dry ingredients.

There are a variety of conventional whisks on the market. What the spring coil whisk provides and which prior art lacks, is the ability to mix and foam ingredients without power. Conventional non-powered whisks mix ingredients but do not produce foam. Traditional bamboo whisks (chasen) require minutes of repetitive motion to mix ingredients and do not produce foam. Electric whisking devices whisk ingredients and produce foam but require batteries and/or a power source. Additionally, electric and bamboo whisks can be fragile, difficult to clean and not suitable for dishwashers, travel or outdoors. The spring coil whisk provides an easier and more efficient alternative to the current market options.

### SUMMARY OF THE INVENTION

The present disclosure provides an apparatus and method for improved mixing and foaming of liquid with or without dry ingredients. The apparatus consists of a cap, a handle portion and a spring coil portion. The spring coil portion is fixed to the handle with threads and in the preferred embodiment, tapered threads.

To use the present invention, the user pulses and/or pumps the handle in an up and down motion. The motion of the handle causes compression and decompression of the spring coil portion. This continued motion mixes and foams any combination of liquid and/or dry ingredients. Beverage powders such as matcha, can be easily mixed and foamed.

### BRIEF DESCRIPTION OF THE DRAWINGS

FIG. 1 is a top perspective view of the spring coil whisk.

FIG. 2 is a bottom perspective view of the spring coil whisk.

FIG. 3 is a top view of the spring of the spring coil whisk.

FIG. 4 is a bottom view of the spring of the spring coil whisk.

FIG. 5 is a side view of the spring coil of the spring coil whisk

FIG. 6 is a side view of the spring coil whisk.

FIG. 7 is a cross sectional view of the handle of the spring coil whisk.

FIG. 8 is a side view of the handle of the spring coil whisk.

FIG. 9 is a cross sectional view of the base of the handle of the spring coil whisk.

FIG. 10a is a perspective view of the cap of the spring coil whisk.

FIG. 10b is a bottom perspective view of the cap of the spring coil whisk.

FIG. 10c is a side view of the cap of the spring coil whisk.

FIG. 10d is a cross sectional view of the cap of the spring coil whisk.

FIG. 11 is a perspective view of the spring of the spring coil whisk with an ornamental design.

FIG. 12 is a perspective view of the spring of the spring coil whisk without an ornamental design.

### DESCRIPTION OF THE PREFERRED EMBODIMENT

The following detailed description refers to the preferred embodiment of the disclosed invention as shown in the attached figures and in the below description. This detailed description is not meant to limit the scope of the invention in any way but is intended to disclose the preferred embodiment/best mode of the invention at the time of filing this application.

The present invention is a whisk for mixing one or more materials. The material may be a liquid and the whisk may be used to agitate or foam the liquid. The liquid may contain a dry ingredient for mixing with the liquid or may be foamed alone. Liquids of any temperature may be foamed with the present invention.

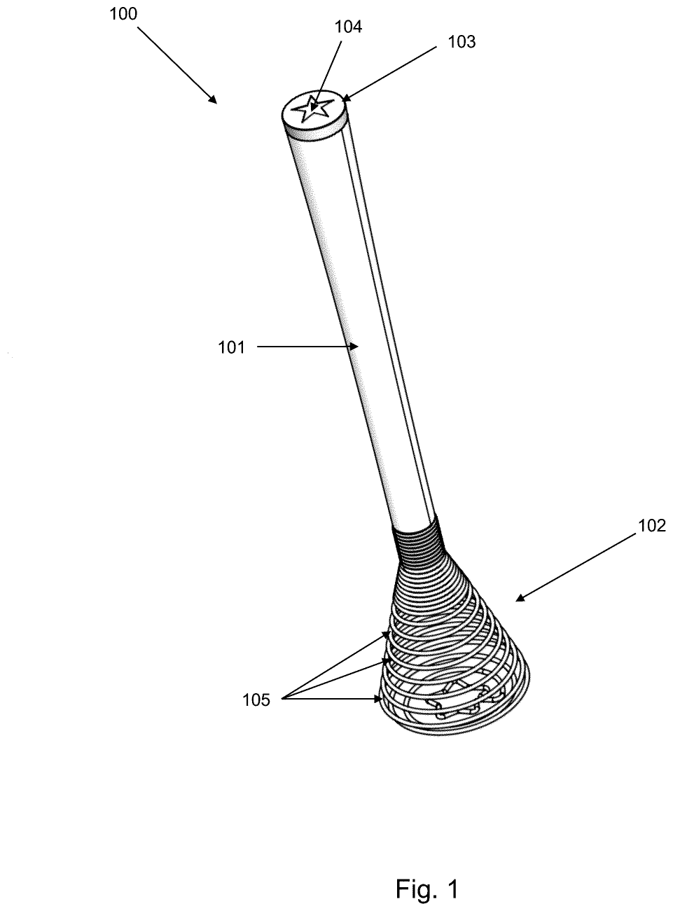

FIG. 1 shows a top perspective view of the spring coil whisk 100. Spring coil whisk 100 is comprised of handle 101, spring coil 102 and cap 103. In the preferred embodiment, cap 103 includes cap ornamental design 104, in this case a star. Spring coil 102 may also include an ornamental design as will be shown in a later figure.

In the preferred embodiment, handle 101 is manufactured out of solid Acrylonitrile Butadiene Styrene (“ABS”) plastic. In other embodiments, handle 101 may be hollow or made from another suitable material such as various other plastics, nylon, various types of wood including bamboo, steel, stainless steel, aluminum, copper, bakelite, silicone, glass, ceramic, polymers, composites, or any other suitable sturdy material. Further, combinations of any of the listed materials or of any suitable material well known in the art may also be utilized.

Spring coil 102 is a helical shaped mechanical device that stores potential energy, resists compression and when decompressed returns to its original shape. Specifically, spring coil 102 is a conical coil spring formed of an elastic material formed in essentially circular coils 105 increasing in diameter from the top of the coil 105, where it is attached to handle 101, to the base of the coil, where it rests against a surface, such as the interior of a cup. Spring coil 102 includes the characteristic of spring rate, meaning the amount of weight required to depress the spring by one inch. Creation of spring coil 102 with a specific spring rate occurs by a combination of spring material, diameter of the spring material, distance between each coil 105, and diameter of each coil 105. The characteristics of spring coil 102 will be discussed in greater detail in relation to a later figure.

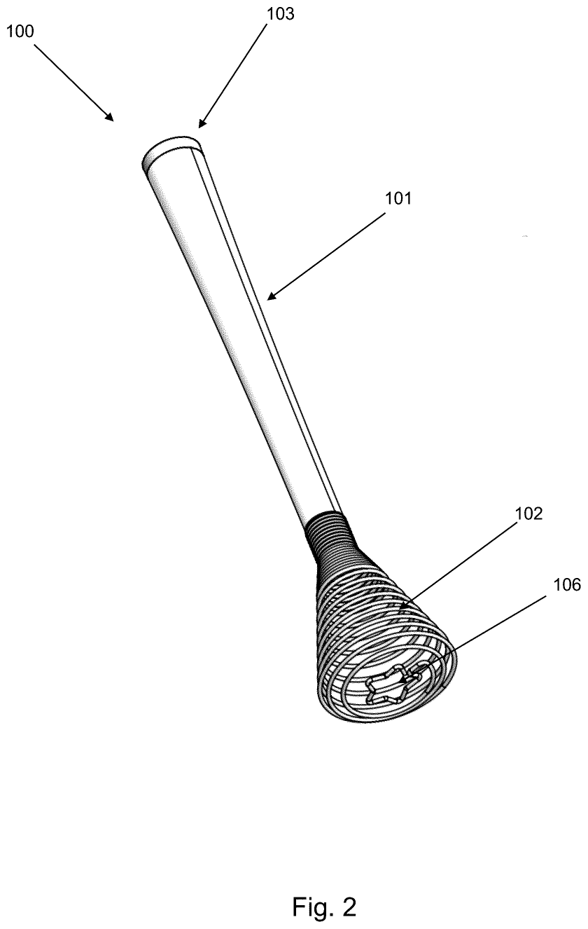

FIG. 2 shows a bottom perspective view of spring coil whisk 100 with its constituent parts, handle 101, cap 103 and spring coil 102. In this view of the preferred embodiment, spring coil 102 includes an ornamental design 106.

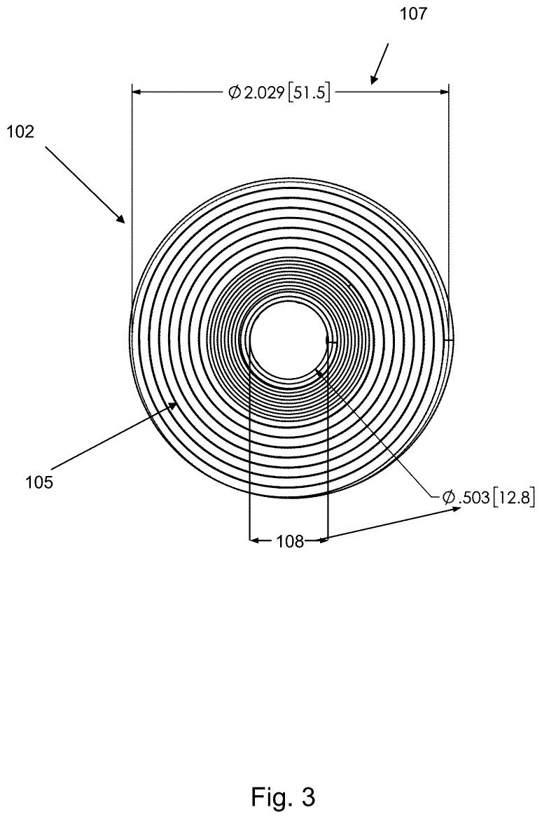

FIG. 3 shows a top view of spring coil 102 without handle 101 installed. In this view, first coil diameter 107 is shown, which is the distance across the largest coil of spring coil 102. In the preferred embodiment, first coil diameter is 51.5 mm, but any suitable first spring coil diameter may be utilized. Second coil diameter 108 is the internal diameter of the smallest coil 105 of spring coil 102, in the preferred embodiment 12.8 mm, though any suitable second coil diameter may be utilized. Each coil 105 has a diameter which varies generally between first coil diameter 107 and second coil diameter 108. Spring coil 102 is formed of individual coils 105.

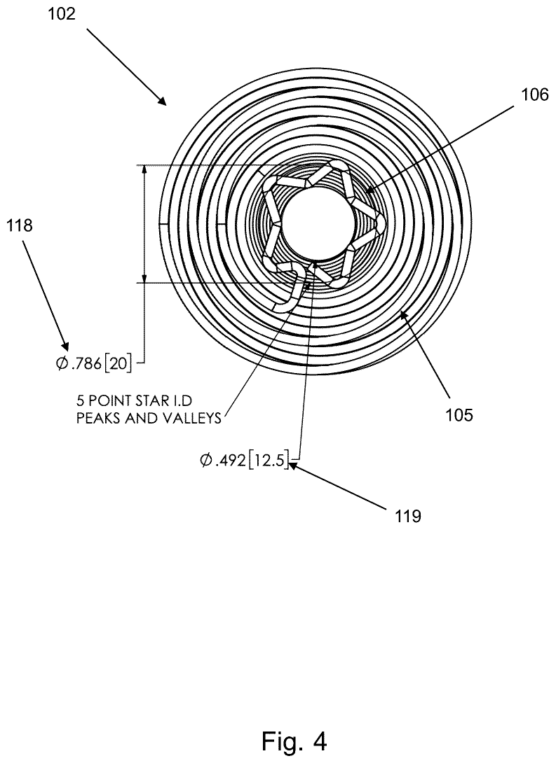

FIG. 4 shows a bottom view of spring coil 102. In this view, spring ornamental design 106 is shown, in the preferred embodiment, as a five pointed star. Max design dimension 118 is defined as the maximum measured distance across ornamental design 106, which in this case is the distance between two of the outside points of the star. In the preferred embodiment, max design dimension 118 is 20 mm but any suitable max design dimension may be utilized. Min design dimension 119 is defined as the minimum measured distance across ornamental design 106, which in this case is the distance between two of the inside points of the star. In the preferred embodiment, min design dimension 119 is 12.5 mm, but any suitable min design dimension 119 may be utilized. Any ornamental design is suitable for spring ornamental design.

In the preferred embodiment, each coil 105 of spring coil 102 is made up of wire with a generally circular cross section measured by cross section 119, in this case the diameter of the wire. While wire with a circular cross section is used in the preferred embodiment, coil 105 may be formed of material in any suitable shape and cross section to provide the spring rate desired for the application.

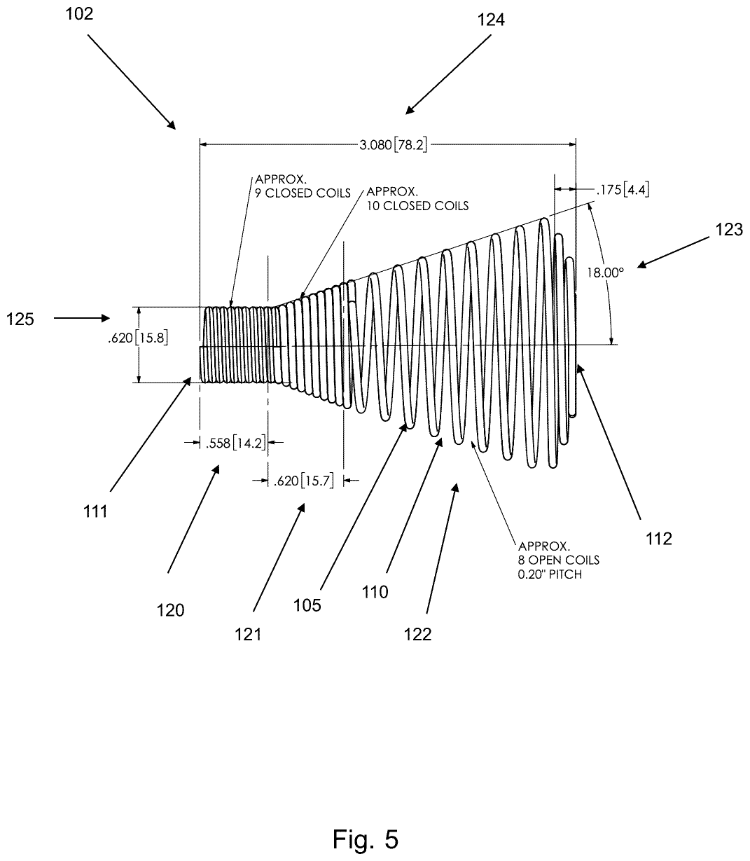

FIG. 5 is a side view of spring coil 102. Spring coil 102 is comprised of three sections: 1) top section 120, 2) mid-section 121, and 3) bottom section 122. The top, and upper dimension, of spring coil 102 is handle coupling 111. The bottom, and lower dimension, of spring coil 102 is spring coil base 112. The spring coil height 124 is the distance from handle coupling 111 and spring coil base 112. In the preferred embodiment, spring coil height 124 is 78.2 mm but any suitable spring coil height 124 may be utilized.

Top section 120, in the preferred embodiment, is comprised of 9 closed coils (i.e. with no vertical distance between the coils), of the same diameter. The external diameter of the coils of top section 120 is 15.8 mm. The height of top section 120 is 14.2 mm. The number of coils, configuration and dimensions are those of the preferred embodiment but any suitable configuration and dimensions may be used to achieve the spring characteristics desired.

Mid-section 121, in the preferred embodiment, is comprised of 10 closed coils (i.e. with no vertical distance between the coils), of increasing diameter. The height of top section 120 is 15.7 mm. The number of coils, configuration and dimensions are those of the preferred embodiment but any suitable configuration and dimensions may be used to achieve the spring characteristics desired.

Bottom section 122, in the preferred embodiment, is comprised of 8 open coils of increasing diameter. Coils of bottom section 122 have a pitch 110, defined as the vertical distance between each coil 105 of spring coil 102. Pitch 110 is.20″ or 5.08 mm in the preferred embodiment. The height of bottom section 122 is 48.3 mm. The number of coils, pitch, configuration and dimensions are those of the preferred embodiment but any suitable configuration, pitch, and dimensions may be used to achieve the spring characteristics desired. Spring angle 123 is the angle formed by a line bisecting the center of spring coil 102 and the largest diameter coil 105 in the spring coil. In the preferred embodiment, spring angle 123 is 18.0 degrees, but any suitable spring angle 123 may be utilized.

Spring coil 102 is formed of appropriate materials that provide desired spring characteristics including stainless steel, steel, aluminum, copper, various alloys, plastics, nylon, polymers, ceramics, composites or any other suitable material well known in the art.

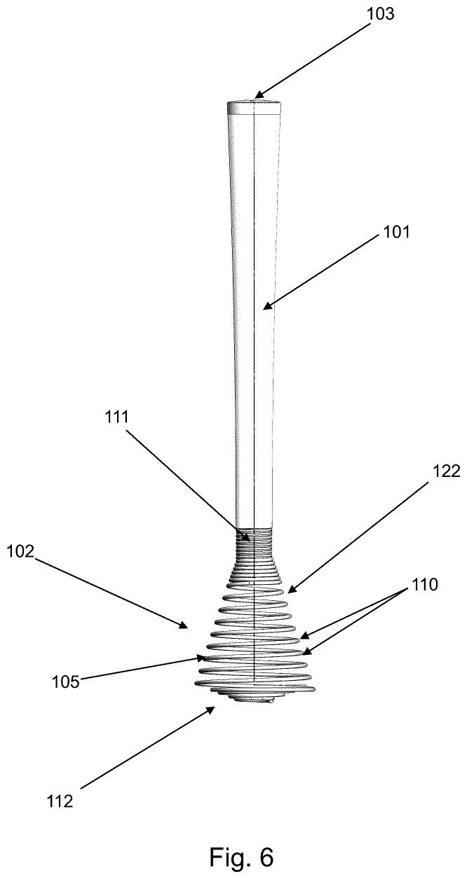

FIG. 6 shows a side view of spring coil whisk 100. In this view, the pitch 110 bottom section 122 of spring coil 102 is clearly visible. Pitch 110 is defined as the distance between each coil 105 of spring coil 102. Pitch 110 is a further characteristic that contributes to the spring rate of spring coil 102 and in the preferred embodiment is 5.08 mm.

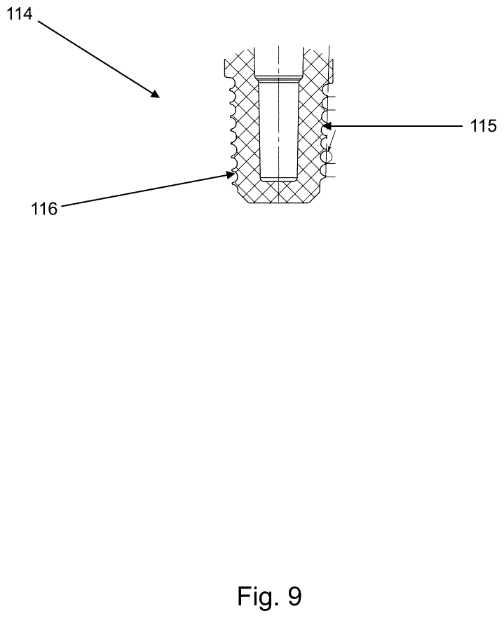

Also visible in FIG. 6 are spring coil base 112 and handle coupling 111 of spring coil 102. In the preferred embodiment, handle coupling 111 is wire sized and formed to fit in complementary threads of spring coupling 114 as shown in FIG. 9.

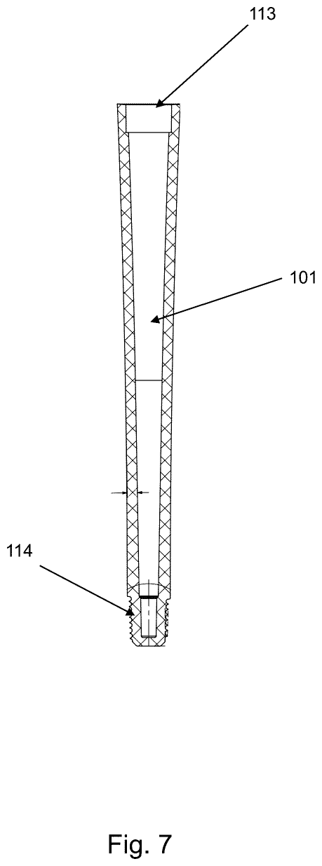

FIG. 7 shows a side cross sectional view of a hollow version of handle 101. In this view, cap coupling 113 is visible. In the preferred embodiment, cap opening 113 is a receptacle shaped and sized to couple with the end of cap 103 to secure cap 103 to handle 101. Any type of suitable coupling could be used including threads, tabs or any other attachment means well known in the art. Also shown is spring coupling 114 which is the threaded end of handle 101 designed to couple with similarly sized and shaped complementary threads on coil coupling 111 to secure spring coil 102 to handle 101.

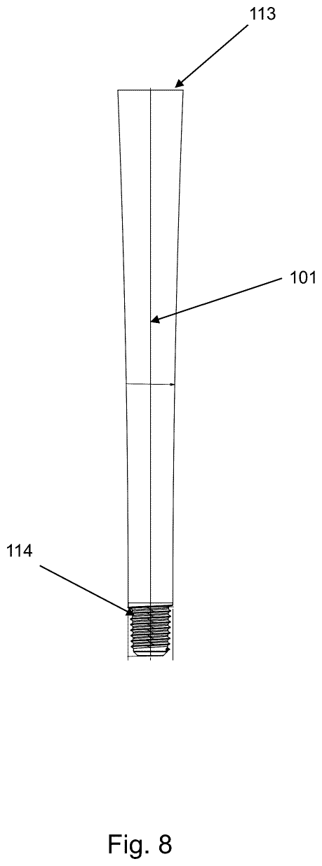

FIG. 8 shows a side view of a solid version of handle 101. In this view, cap opening 113 is located at the top of handle 101. Threaded spring coupling 114 is shown at the opposite end of handle 101.

FIG. 9 shows a detailed view of spring coupling 114. In the preferred embodiment, a tapered thread with increasing pitch is utilized. Specifically, the base of spring coupling 114 has a smaller dimension (diameter, radius or circumference) than the top of spring coupling 114. In other words, the length of spring coupling 114, when viewed in side cross section, has a slight angle from top to base. Thread distance 115 shows the distance between two threads, when measured from the top of the first thread to the top of the second thread. In the preferred embodiment, this distance is 1.9 mm but any suitable distance may be used. Thread gauge 116 shows the diameter of a wire that would fit in the circular thread of spring coupling 114. In the preferred embodiment, this diameter is 1.6 mm but any suitable diameter may be used.

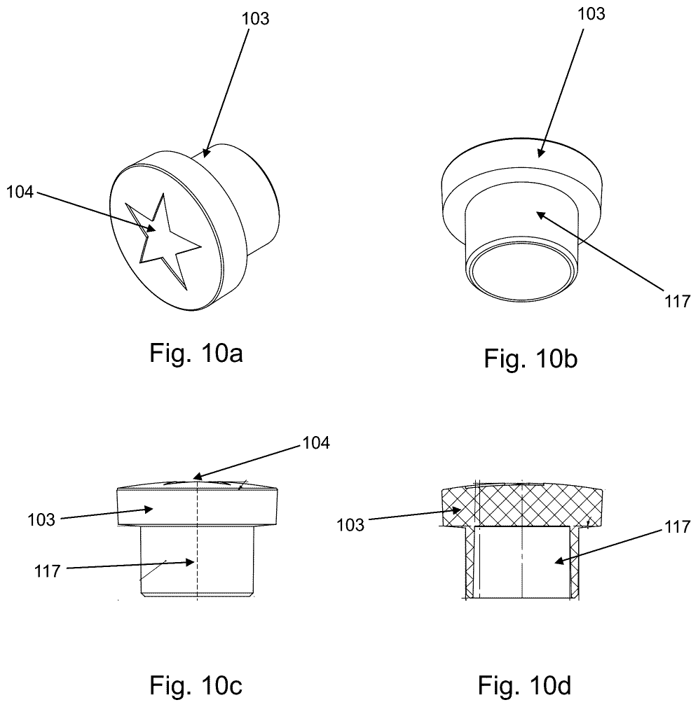

FIGS. 10a-10d show various views of cap 103. FIG. 10a is a perspective view of cap 103 with cap ornamental design 104 clearly shown. FIG. 10b is an underside perspective view of cap 103 with cap base 117 shown. Cap base 117 is sized to securely couple with the similarly sized opening in cap coupling 113 to secure cap 103 to handle 101. FIG. 10c shows a side view of cap 103 with cap base 117 shown. FIG. 10d shows a cross sectional view of cap 103 with cap base 117 visible. In the preferred embodiment, the height of cap 103 is 15.9 mm. The width of cap 103 (at the top) is 21.9 mm. The width of the base of cap base 117 is 15.7 mm. These are the measurements of the cap 103 in the preferred embodiment but cap 103 may be manufactured in any suitable size. The cap is made of ABS plated with a metal finish in this embodiment.

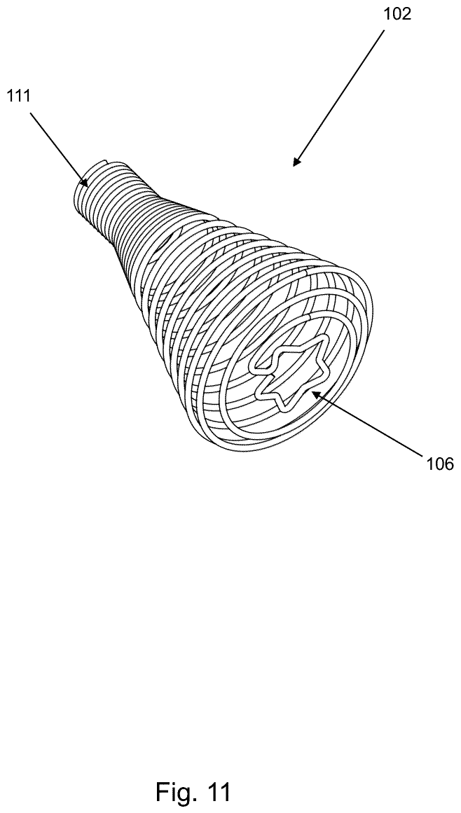

FIG. 11 is a perspective view of whisk 102 with spring ornamental design 106 shown, in this embodiment a star.

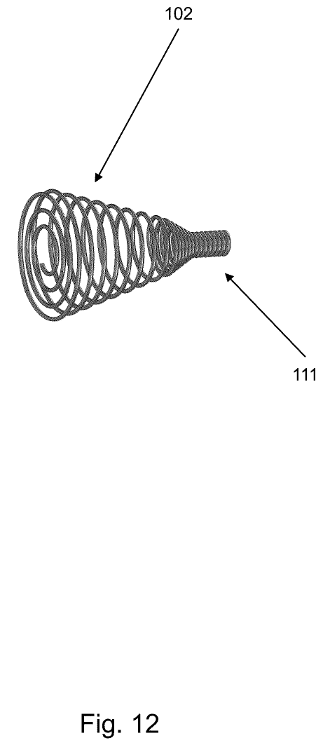

FIG. 12 is a perspective view of whisk 102 without a spring ornamental design.

Although the present invention has been described in relation to the above disclosed preferred embodiment, many modifications in design, implementation, systems and execution are possible while still maintaining the novel features and 11 advantages of the invention. The preferred embodiment is not meant to limit the scope of the patent in any way, and it should be given the broadest possible interpretation consistent with the language of the disclosure on the whole.

1. A whisk for mixing one or more materials comprising:
a handle having a top and a base;
a cap coupled at the top of the handle; and
a spring coupled at the base of the handle wherein the spring may be compressed and decompressed to mix the one or more materials.

2. The whisk of claim 1 where the cap further comprises a base sized to couple with an opening in at the top of the handle.

3. The whisk of claim 1 where the cap further comprises a location for an ornamental design.

4. The whisk of claim 1 where the cap is manufactured of a material selected from the group consisting of acrylonitrile butadiene styrene, acrylonitrile butadiene styrene plated with metal, plastic, nylon, wood, bamboo, steel, stainless steel, aluminum, copper, bakelite, silicone, glass, and ceramic.

5. The whisk of claim 1 where the spring is coupled to the handle by threads.

6. The whisk of claim 1 where the handle is manufactured of a material selected from the group consisting of acrylonitrile butadiene styrene, acrylonitrile butadiene styrene plated with metal, plastic, nylon, wood, bamboo, steel, stainless steel, aluminum, copper, bakelite, silicone, glass, and ceramic.

7. The whisk of claim 1 where the spring is comprised of a coupling end and a base end where the base end includes a location for an ornamental design.

8. The whisk of claim 1 where the spring comprises spring coils with a diameter and where the diameter of the spring coils at the spring base is larger than the diameter of the spring coils at the handle coupling.

9. The whisk of claim 1 where the spring is manufactured of a material selected from the group consisting of stainless steel, steel, aluminum, copper, various alloys, plastics, and nylon.
